(19) United States
(12) Patent Application Publication
(10) Pub. No.: US 2018/0082078 A1
(43) Pub. Date: Mar. 22, 2018

(54) Confidential Data Processing System

(71) Applicant: Hitachi, Ltd., Chiyoda-ku, Tokyo (JP)

(72) Inventors: Takayuki SUZUKI, Tokyo (JP); Go KOJIMA, Tokyo (JP); Yoshinori SATOU, Tokyo (JP); Keisei FUJIWARA, Tokyo (JP)

(21) Appl. No.: 15/558,501

(22) PCT Filed: Mar. 15, 2016
(86) PCT No.: PCT/JP2016/058178

§ 371 Date: Sep. 14, 2017

(30) Foreign Application Priority Data
Mar. 19, 2015 (JP) 2015-055580

(51) Int. Cl. G06F 21/62; G06F 21/60; H04L 29/06; G06F 17/30

(52) U.S. Cl. CPC G06F 21/6227; G06F 21/602; G06F 17/30289; H04L 63/06; H04L 63/0428

(57) ABSTRACT

Encryption methods allowing encrypted data to be stored in a database and processed in the encrypted state have been proposed. However, since it is necessary for an application to use plaintext data, usage is only possible where security is assured. When an application for processing encrypted data stored in a database is used from a user system, the application is launched from the user system via an application extension unit. When the application processes the encrypted data stored in the database, the application extension unit performs a process in which, if an encryption SQL function enabling the encrypted data stored in the database to be processed is registered, the SQL function enabling the function for processing plaintext is replaced with the encryption SQL function, and, if a substitution process is registered, the SQL function is replaced with a substitution process function enabling the substitution process to be performed. It is thereby made possible to process data, without decryption, in a location at which security is not assured.

### TECHNICAL FIELD

The present invention relates to a system configured to utilize encrypted data.

### BACKGROUND ART

In various kinds of information systems, for example, personal information such as the name, address, and current position of a user, and living body information of the user should not be provided outside of the system. However, in reality, there are systems needed to be operated by using such information.

In a method as a measure against this, an environment physically separated from other systems is established for operation. This method is effective against data leakage but is likely to be costly.

In a method as another measure, data is encrypted to reduce a leakage risk. No meaningful information can be directly acquired from the encrypted data even when data leakage occurs, and thus the data can be securely handled. This can be achieved by using data encryption functions provided by databases used in many systems.

A cloud environment has become widely used to achieve reduction of running cost of a system and fast use of computer resources. As a result, an increasing amount of data to be confidential in the system is expected to be accumulated in the cloud environment.

In a conventional method, data encryption is performed at a database, and thus, when the database operates in an environment such as a cloud outside of a conventional system, key information used for encryption processing at the database needs to be stored where the database is used, in other words, outside of the system. Thus, data leakage potentially occurs such that an external resource manager such as a cloud service provider acquires the content of confidential data by using an encryption key specified by a user.

A disclosed solution to deal with such a problem uses a special encryption scheme that allows data to be processed in an encrypted state. However, computation that allows processing in an encrypted state is currently restricted depending on an encryption scheme. A disclosed method takes the restriction into account and changes an encryption processing scheme to be used in accordance with an application or predetermined configuration information (PTL 1). In another disclosed method, the restriction is handled by preparing data for various encryption schemes in advance (NPL 1).

### CITATION LIST

### Patent Literature

[PTL 1] Japanese Patent Laid-open No. 2014-013582

### Non Patent Literature

[NPL 1] CyrptDB http://people.csail.mit.edu/nickolai/papers/raluca-cryptdb.pdf

### SUMMARY OF INVENTION

### Technical Problem

These methods can handle various encryption schemes, but an application needs to operate by using decrypted raw data and thus can operate only in a secure environment. This prevents free use of various applications provided in cloud environments such as Platform as a Service (PaaS) and Software as a Service (SaaS).

### Solution to Problem

The present invention changes processing at an application so that processing on encrypted data can be performed in a secure environment irrespective of processing restriction due to an encryption scheme. For example, part of original application processing, which is operated on encrypted data, is replaced with processing converted into a character string, and the processing converted into a character string and the encrypted data are transmitted to a secure environment where the encrypted data is decrypted and the processing converted into a character string is executed.

### Advantageous Effects of Invention

The present invention allows encryption data to be processed without decryption in an external environment. Accordingly, a data leakage risk can be reduced. In addition, an application does not need to consider whether data is encrypted, and thus can be freely implemented and securely use an application developed by any other company. Moreover, a user can use an encryption scheme in accordance with a use case or a request, and an application developer can perform development without considering restriction due to an encryption scheme used.

### BRIEF DESCRIPTION OF DRAWINGS

FIG. 1 is an exemplary configuration diagram in an embodiment of the present invention.

FIG. 2 is an exemplary logic configuration diagram of a case in which an application and a database are provided outside of a user system in the embodiment.

FIG. 3 illustrates an exemplary encryption processing correspondence table in the embodiment.

FIG. 4 illustrates an exemplary application conversion processing flow in the embodiment.

FIG. 5 illustrates part of an exemplary parameter operation storage table in the embodiment.

FIG. 6 illustrates part of an exemplary parameter operation storage table in the embodiment.

FIG. 7 illustrates an exemplary processing flow in the case in which the application and the database are provided outside of the user system in the embodiment.

FIG. 8 illustrates an exemplary processing flow of detection and encryption of encryption target data at a confidential processing unit in the embodiment.

FIG. 9 illustrates an exemplary encryption data correspondence table in the embodiment.

FIG. 10 illustrates an exemplary user interface through which an encryption scheme is configured for a column and a parameter in the embodiment.

FIG. 11 illustrates an exemplary processing flow of a case in which processing is requested from the application and the confidential processing unit to the database in the embodiment.

FIG. 12 illustrates an exemplary processing flow at the application and an application extension unit after a result of database processing in the embodiment.

FIG. 13 illustrates a processing flow at the confidential processing unit after application processing in the embodiment.

FIG. 14 illustrates a processing example at SQL function change in the embodiment.

FIG. 15 illustrates a processing example at application processing change in the embodiment.

FIG. 16 illustrates another exemplary configuration diagram in the embodiment of the present invention.

### DESCRIPTION OF EMBODIMENT

An embodiment of the present invention will be described below with reference to the accompanying drawings. The present embodiment does not limit the present invention.

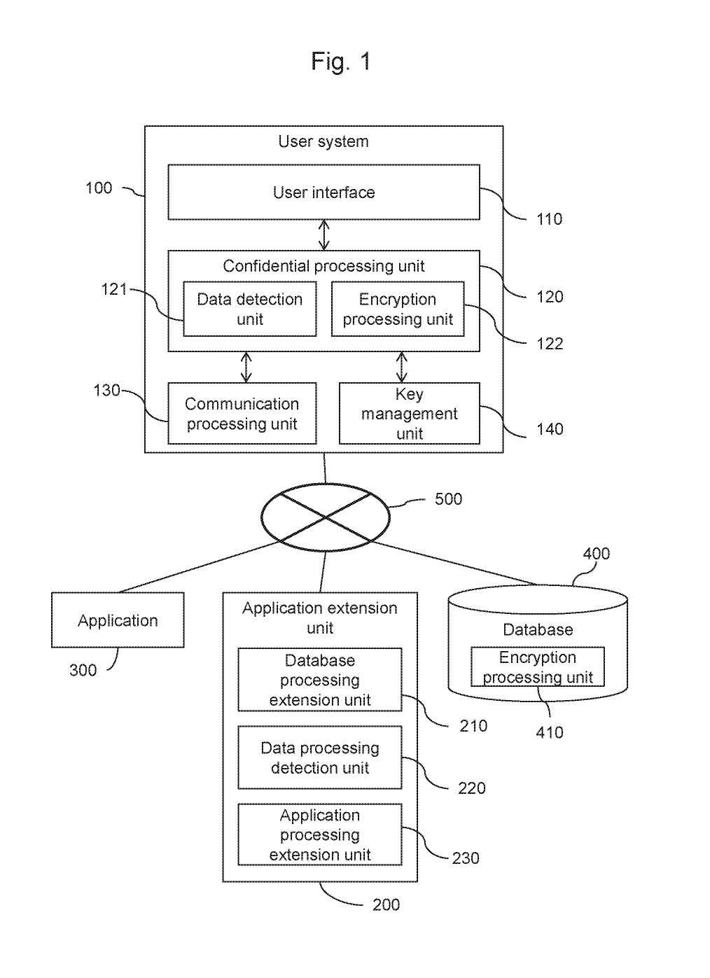

FIG. 1 illustrates an exemplary configuration of an entire system in an embodiment for achieving the present invention. The system is roughly composed of a user system 100 and the other part coupled with the user system 100 through a network 500.

The user system 100 includes a user interface 110 used to, for example, present results of reception and processing of an operation from a user, a confidential processing unit 120 configured to perform encryption processing on data, a key management unit 140 for securely handling key information necessary for use in the encryption processing, and a communication unit 130 for mutual communication with the external environment. In FIG. 1, the user system 100 is illustrated as a single processing instrument, but these processing units may be each mounted in a separate instrument and coupled with each other through an internal network established in the user system. An application (not illustrated) configured to perform different processing may be included in the user system 100 and operate in cooperation with the user interface 100 and the confidential processing unit 120. The key management unit 140 may be implemented by, for example, a method of storing key information in a file to which appropriate access authority is configured, or a method of managing key information in a hardware chip having a tamper resistant function or a separate server such as a hardware secure module (HSM).

The user system 100 is an area in which security is assured, in other words, an area in which data can be securely handled, such as an on-premise environment of a company. Accordingly, data does not necessarily need to be encrypted inside the user system 100 and can be used without encryption. In the present configuration, when raw data is provided to the outside of the user system 100, confidential data is encrypted through the confidential processing unit 120, and then system information and another function coupled with the external network 500 through a communication processing unit 130 are provided. External encrypted data received by the communication processing unit 130 from the network 500 is decrypted into raw data at the confidential processing unit 120 for use inside the user system 100.

The user system 100 uses an application extension unit 200, an application 300, and a database 400 through the network 500. The application extension unit 200 includes a database processing extension unit 210, a data processing detection unit 220, and an application processing extension unit 230. The application extension unit 200 provides a function for processing encryption data without problems when an application is operated in an unsecure area outside of the user system like the present configuration. For example, the application extension unit 200 is provided as a function inside a platform that provides PaaS or SaaS. When provided as part of a platform, the application extension unit 200, the existing application 300 and database 400 allows to execute an application without considering the existence of the application extension unit 200 nor restriction on computation by an encryption scheme.

The application 300 may be any application. Examples of the application 300 include published third-party and open source applications. The examples include any application developed by the user.

The database 400 is used to store data provided from the user system 100 or data processed by the application 300. The database includes an encryption processing unit 410 compatible with encryption processing and a function of which is called to execute processing on encrypted data. Specifically, the encryption processing unit 410 is achieved by, for example, a user definition function (UDF). This function, which is provided by the database, can be used to add unique processing without changing the database.

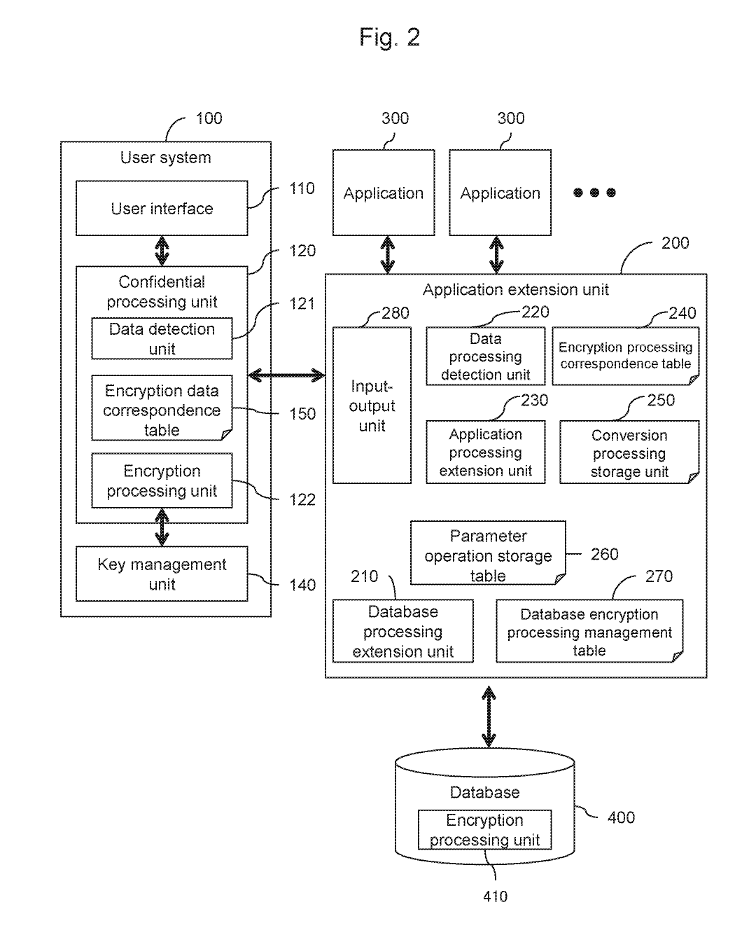

The network 500 is a network for allowing these functions to cooperate with each other. The network 500 is, for example, the Internet. Any communication protocol and any physical configuration are applicable as long as they allow the cooperation of the functions. FIG. 1 illustrates a physical arrangement of components, and FIG. 2 is a sorted diagram focusing on cooperation of processing units illustrated in FIG. 1. In addition to the components illustrated in FIG. 1, the confidential processing unit 120 includes an encryption data correspondence table 150 defining which data among data notified to an application or a database is to be encrypted in which encryption scheme. The application extension unit 200 includes an encryption processing correspondence table 240 defining which encryption processing is to be used in response to a request from the user system and listing computation and the like that can be processed by this encryption scheme, a conversion processing storage unit 250 to be used when database processing is changed, a parameter operation storage table 260, a database encryption compatible processing management table 270, and an input-output unit 280 configured to perform inputting and outputting for the user system and the database.

The application extension unit 200 operates as a platform for operating the application 300. Specifically, the application 300 communicates with the user system 100 or the database 400 through the application extension unit 200. Although not illustrated in FIG. 2, the communication processing unit 130 is provided between the confidential processing unit 120 and the application extension unit 200. This example assumes that the user system 100, the application extension unit 200, the application 300, and the database 400 in FIGS. 1 and 2 operate in separate environments, and unencrypted data can be handled inside the user system 100 only.

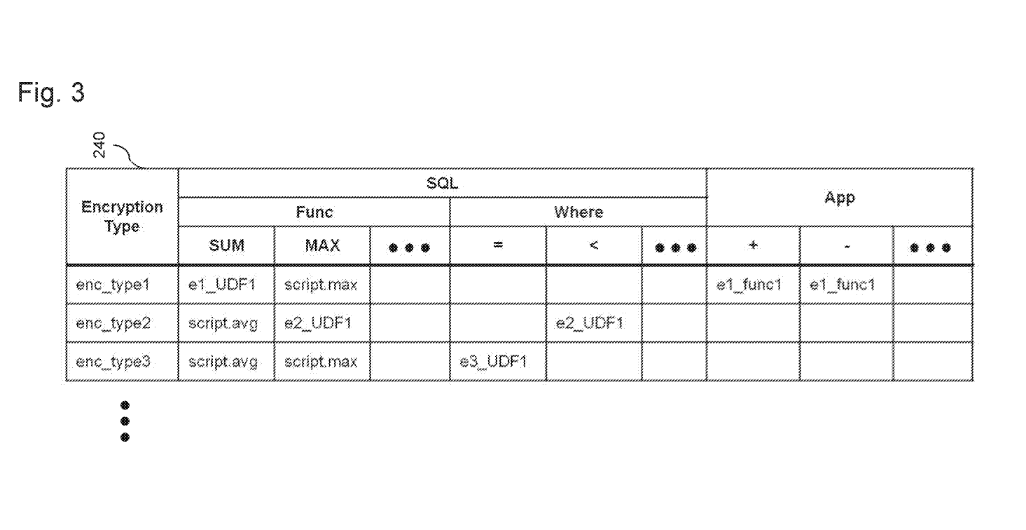

Recently developed encryption algorithms allow computation on data in an encrypted state but not all kinds of computation. Specifically, an encryption scheme allows addition and subtraction on data in an encrypted state but not modular calculation, and another encryption scheme allows match determination but not magnification comparison. In this manner, processing on data in an encrypted state is restricted depending on a scheme. The encryption processing correspondence table 240 illustrated in FIG. 3 manages processing to be specifically called to perform computation in the restriction and the encrypted state.

Data notified from the user system is used to perform various computations inside the application and used as an argument of a function (for example, an SQL function) performed in the database as necessary, and then the database is requested to process the data. The application receiving a response from the database performs various computations on the response as necessary and returns the response to the user system. In the present example, data is encrypted when used outside of the user system. Thus, a processing unit and an SQL function for data notified to the application by the user system and the database need to be changed to processing compatible with an encryption scheme in use. The encryption processing correspondence table 240 stores the content of the change. Specifically, the encryption processing correspondence table 240 lists, in SQL column, an encryption processing SQL function that is called for an SQL function for processing plaintext data and processes encrypted data, and in App column, an encryption processing compatible function called for processing performed on received data by the application. Not only a function corresponding to computation one-on-one but also, for example, a script for performing change may be registered.

Addition and change to this content can be performed as necessary to handle a new encryption scheme and new computation. The encryption processing correspondence table 240 stores a processing method corresponding to an encryption scheme through configuration in advance, addition in response to a user request, or the like.

The present invention can be roughly divided into two pieces of processing “change of existing application for encryption processing” and “change of user request and response for encryption compatible processing” to handle encryption. The following describes the “change of existing application for encryption processing”.

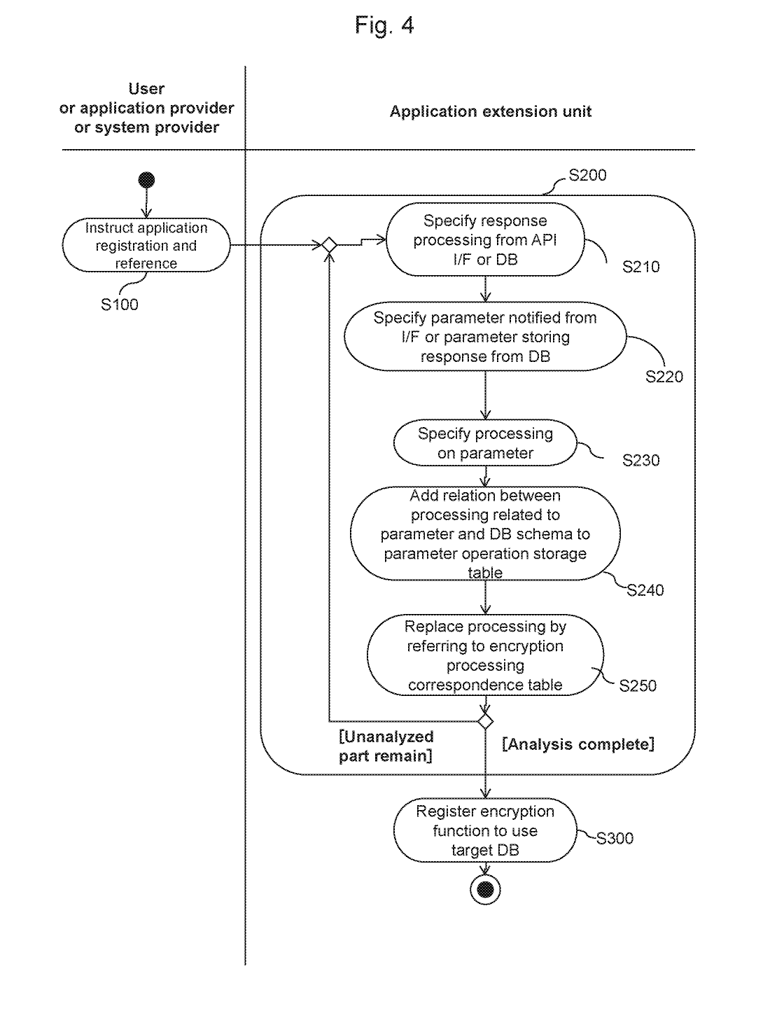

FIG. 4 illustrates the flow of processing of changing an original application to an application compatible with an encryption scheme. First, when a user accesses an application that the user desired to use, an application provider registers an application thereof to the application extension unit, or a system provider registers an application in advance, for example, the application extension unit 200 receives an application as a change target (step S100), and changes the application to an encryption compatible application (step S200).

Having received the change target application, the application extension unit 200 analyzes the application at the data processing detection unit 220 and specifies processing that the application receives a parameter from the user (step S210). Then, the application extension unit 200 specifies the parameter notified through this interface (step S220).

For example, when the application is a Web application using REST, processing of determining processing parts corresponding to methods such as GET and POST of HTTP and determining parameters notified through these processing parts is executed. The notified parameters are used in the application, and thus the analysis is continued to specifically determine which processing the parameters are used (step S230).

At this processing step, usage of a parameter storing a return value from the database is also analyzed. When a part executing processing that uses a parameter as a trace target is specified, the content thereof is added to the parameter operation storage table 260 (step S240). This specified part is a part to be replaced with encryption compatible processing, and thus, the application processing extension unit 230 replaces processing of the application to allow execution of processing on an encrypted parameter by referring to the encryption processing correspondence table 240 (step S250). For example, in a case with processing of a GET method of a Web application, a parameter of the GET method is encrypted and notified, and thus the application is changed by referring to the encryption processing correspondence table 240 so that processing compatible with each encryption scheme is called. This change can be achieved, for example, by adding processing that bifurcates depending on a parameter encryption scheme, or by extending a parameter expression format in a language in which the application is implemented to produce a format in accordance with an encryption scheme.

Processing not listed in the encryption processing correspondence table 240 cannot be processed in an encrypted state. An exemplary handling method for such processing is a method of converting all processing related to a parameter into a character string. This processing is executed on all interface parts through each of which a parameter is received from the user, and on a response part from the database. For example, when original processing is processing such as “A+B” that adds parameter A and parameter B and returns a result, this processing is changed to processing that returns a character string of the processing “A+B”. This character string is notified to the user system 100 together with encrypted data, and executed at the user system 100.

The entire application is analyzed through this series of processing. In this analysis processing, simultaneously with step S200 at which conversion into encryption compatible processing is performed, specific information on a database used such as MySQL or Oracle is accumulated, and this information is referred to with the database encryption processing management unit 270 to register encryption processing in accordance with the database used (step S300). When it is needed to provide computation unique to encryption on encrypted data stored in the database, this processing needs to be registered to the encryption processing unit 410 of the database in advance.

The database used differs depending on a system, an application, and a user, and thus the database encryption processing management table 270 is used to provide an appropriate encryption processing function in accordance with the difference of the database. Specifically, the database encryption processing management table 270 manages information such as the type of an encryption scheme, the name of processing corresponding to the encryption scheme, and a module (a dynamic library or a jar file of Java (registered trademark), for example) to be registered to a database actually used such as MySQL or Oracle to use the processing. When needed, for example, a script for executing registration processing may be registered. No processing is performed when the same encryption processing is already registered to the database used. When encryption processing cannot be added to the database used, a resource under management by the application extension unit 200 or an external resource may be used to newly provide a database. In this case, an original database configuration used by an application is changed.

When needed, change is performed such that encrypted names of a table and a column used by an original database are used or different names are used. In this case, the changed names of the table and column may be notified to the confidential processing unit 120.

In this exemplary flow of conversion into this encryption compatible processing, change processing is performed at a timing when processing that uses an external parameter notified from the user is found, but replacement with the encryption compatible processing may be performed all at once after analysis of the entire application is ended because information on a change part accumulates in the parameter operation storage table 260.

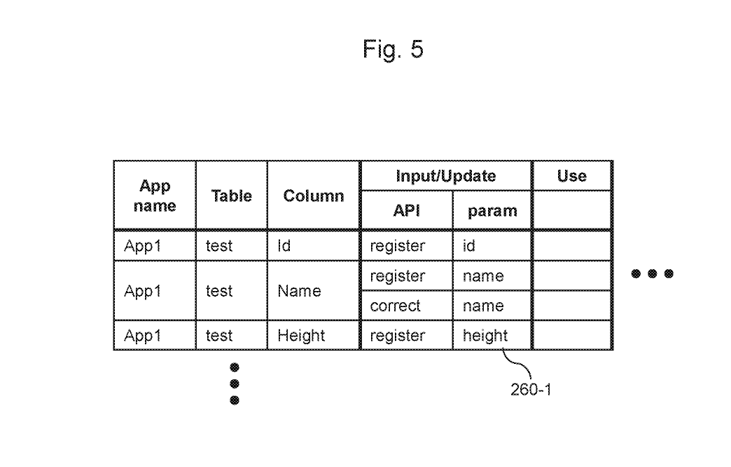

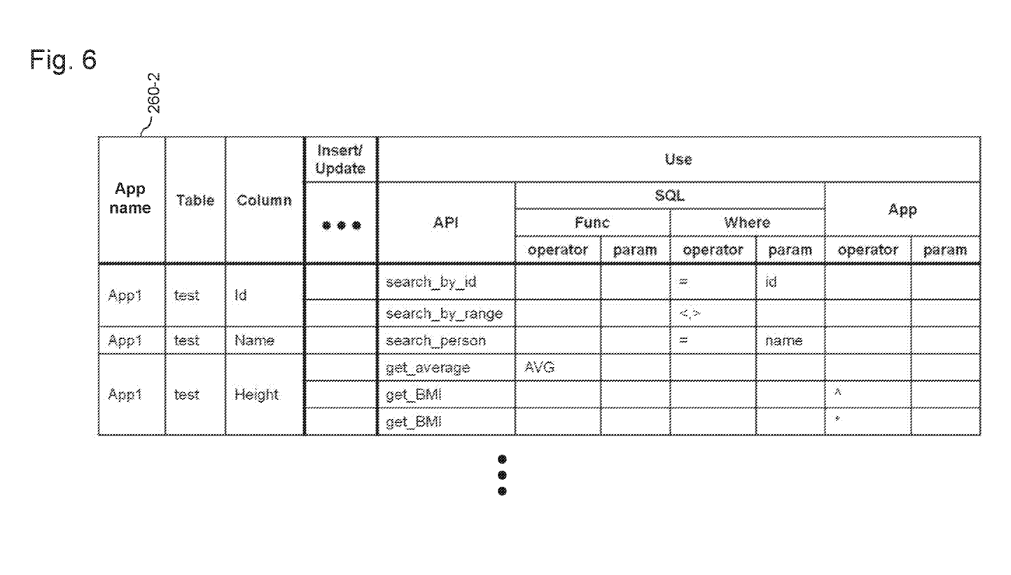

FIGS. 5 and 6 each illustrate an exemplary parameter operation storage table 260 (separated in the two diagrams for sake of illustration, but may be achieved as one table). This table manages information such as an API as an external interface used by the user system 100, a parameter thereof, and a column of a database related to the parameter in association with each other.

The following describes a method of the “change of user request and response for encryption compatible processing”.

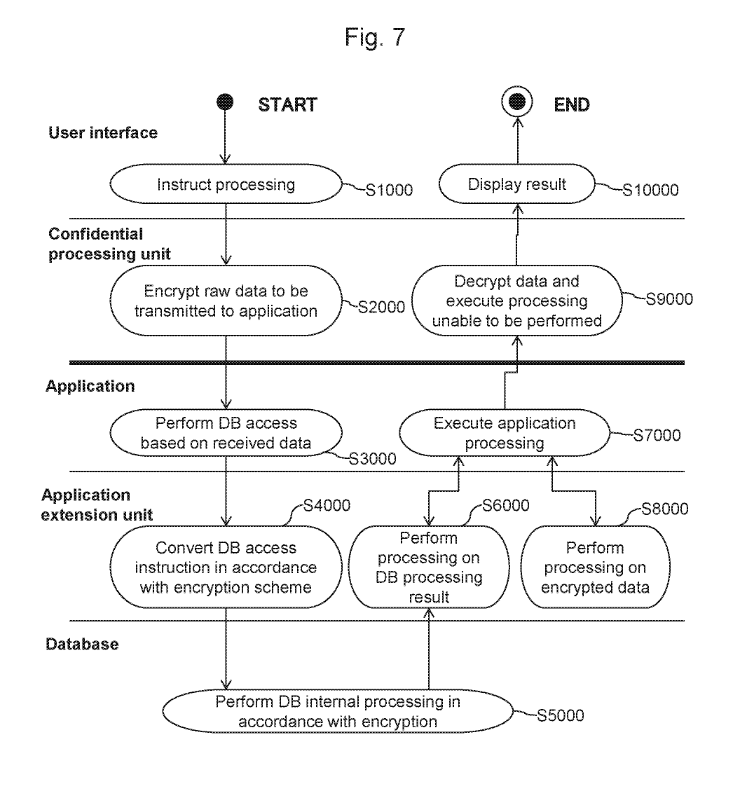

FIG. 7 illustrates a schematic processing flow in the present invention. FIG. 7 exemplarily illustrates processing when encrypted data is already stored in the database 400 and used by the application 300.

The user interface 110 is, for example, a Web browser, and accesses the application 300 outside of the user system 100. The user operates the user interface 110 to transmit data to the application 300 (step S1000). Communication from the user interface 110 to the outside of the user system 100 is first notified to the confidential processing unit 120. The confidential processing unit 120 detects raw data in communication data, encrypts confidential data, and notifies the encrypted confidential data to the application (step S2000).

Having received the data, the application 300 queries to the database 400 by using the data (step S3000). Since the data is encrypted, processing on the data cannot be executed directly. Thus, the application processing extension unit 200 updates the query processing from the application 300 to the database 400 so that processing on the encrypted data is called (step S4000).

The database 400 executes database-side processing based on a notified content and returns a result (step S5000). The result is returned to the application 300, but before this return, the application processing extension unit 200 receives this response, changes the processing result as necessary (step S6000), and then returns the result to the application 300. The application 300 advances own processing using the result (step S7000). Since the returned data is encrypted, the application 300 cannot process the data directly.

Thus, a processing part related to the encrypted data is changed from original processing at the application 300 to processing generated by the application extension unit 200. For example, processing of replacing the processing on the encrypted data with a different expression is executed (step S8000). Then, a result of processing at the application 300, including a result of processing at a use place, is returned to the user system 100 (step S7000). Having received data, the confidential processing unit 120 detects and decrypts encrypted data among the received data. Subsequently, the processing that cannot be externally executed since the data is encrypted and that has been replaced with the different expression is executed (step S9000). The user interface 110 receives a result of the execution and provides the result to the user (step S10000).

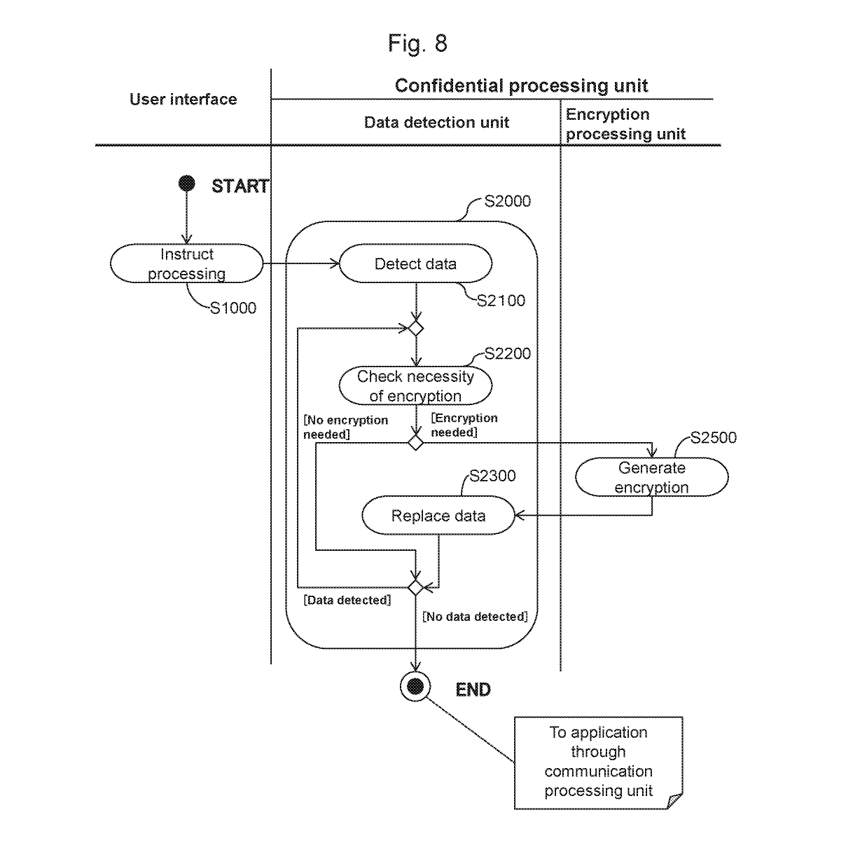

FIG. 8 is a detailed flow of step S2000, illustrating a content processed inside the confidential processing unit 120. Information notified from the user interface 110 to the application 300 is notified to the confidential processing unit 120 (step S1000). A data detection unit 121 inside the confidential processing unit 120 detects a data part of the notified information (step S2100). Subsequently, it is checked whether the detected data needs to be encrypted (step S2200). Specifically, it is determined which data among the detected data needs to be encrypted by referring to the encryption data correspondence table 150.

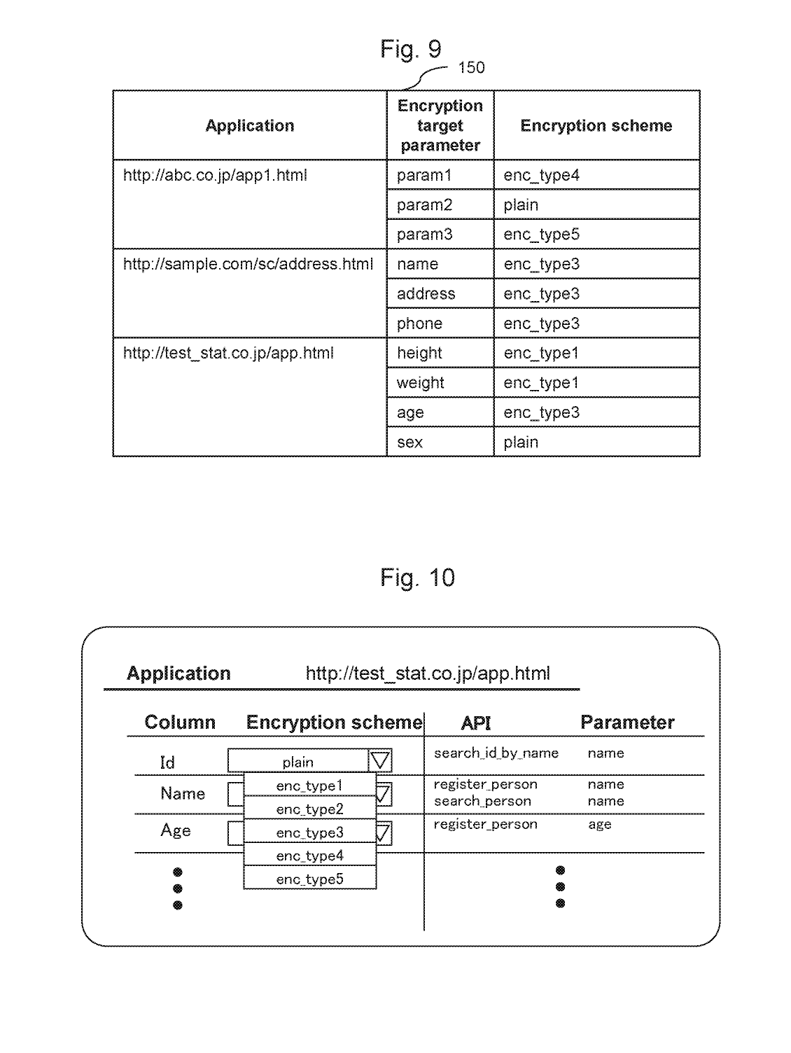

FIG. 9 illustrates an exemplary encryption data correspondence table 150. The table lists an application and which data among data notified to the application and the database is to be encrypted. The necessity of data encryption can be determined only by a user, and thus this information is basically configured by the user of the user system.

For example, a screen as illustrated in FIG. 10 is presented before or right before the user uses an application, and the user is prompted to configure which part of data that the application stores in the database is to be encrypted by which encryption scheme. This screen is produced with reference to the parameter operation storage table 260.

On the screen illustrated in FIG. 10, an encryption scheme is determined through a column name, but may be determined through a parameter. In addition, a correspondence relation between a database storage, and an API and a parameter is presented and thus can be used to suggest an appropriate encryption scheme to the user or perform automatic configuration to some extent. Alternatively, this information may be dynamically generated by the application extension unit receiving inputting of, for example, an encryption strength required by the user system, or an encryption scheme may be fixed for the system or the application so that the information does not need to be provided.

For example, when encrypted names or different names of the names of a table and a column stored in the database 400 are used, the table may store a correspondence relation thereof, and conversion processing may be performed on these names in accordance with change of encryption target data. The encryption data correspondence table 150 may be notified to the application extension unit 200. In this case, the application extension unit 200 manages this information together with information on a requester. In this manner, an encryption scheme and an encryption target parameter can be individually configured for each user.

For example, information on a notification source can be added to the parameter operation storage table 260, and an application can be executed by an encryption processing method in accordance with the user. Alternatively, information on an encryption scheme may be embedded in an encryption parameter notified from the user system 100 to the application extension unit 200. In this scheme, the application extension unit 200 does not need to manage information on a notification source, and the notified encryption scheme can be handled.

When data needs to be encrypted, an encryption processing unit 122 acquires and configures necessary key information in cooperation with the key management unit 140, and encrypts the target data (step S2500). Thereafter, an encryption target data part of information notified from the user interface 110 is replaced with encrypted data (step S2300). This processing is performed on specified data, which ends processing at the confidential processing unit 120, and encrypted information of the specified data is notified to the application 300 through the communication unit 130.

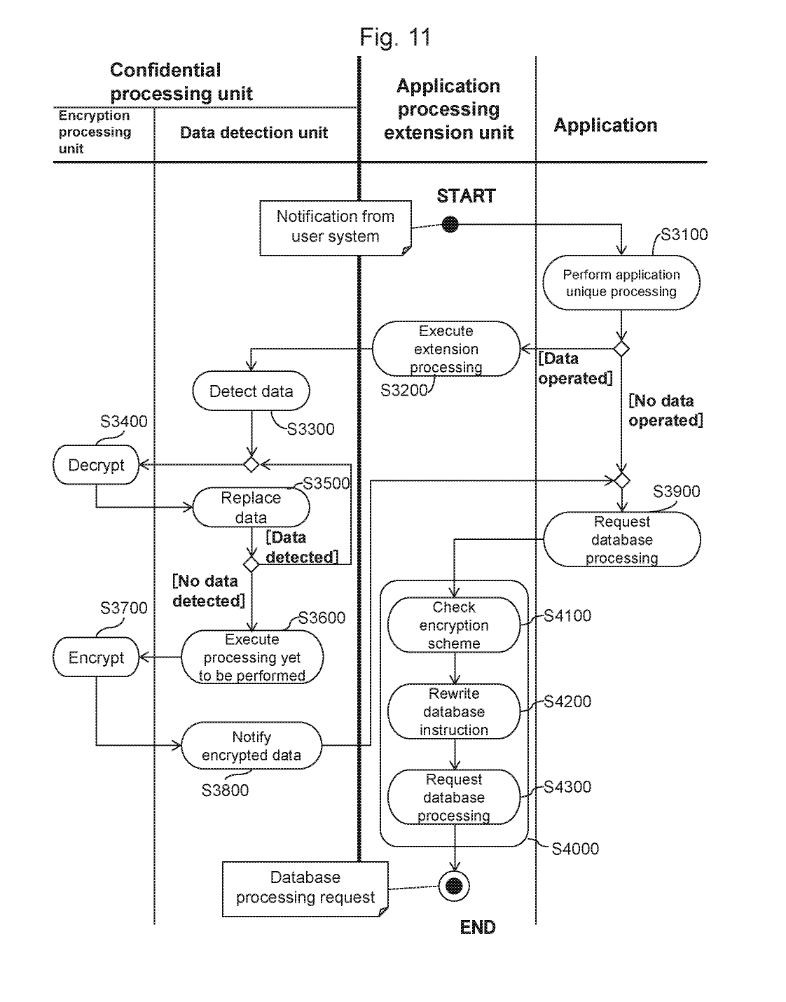

FIG. 11 illustrates a detailed flow of steps S3000 and S4000 processed by the application 300. The flow starts at reception, by the application 300, of information notified from the user system 100 through the application extension unit 200. The application extension unit 200 calls an encryption processing compatible application except for a case in which no encryption processing compatible application is stored, such as a case in which an application is dynamically replaced with encryption compatible processing. When an application is specified for the first time, processing of a called API is first changed to encryption compatible processing and then executed.

Having received the information from the user system 100, the encryption processing compatible application 300 executes unique processing by using this data. This processing is roughly divided into a case in which encrypted data notified from the user system 100 is processed, and a case in which the data is not processed but directly used.

For example, when the encrypted data received from the application 100 is directly set to a SQL, no processing occurs on the encrypted data, and thus the database is requested to directly process the data (step S3900). When any operation is performed on the encrypted data, processing changed by the application extension unit 200 is called (step S3200). The following description assumes that processing on a notified parameter is converted into a character string. When the processing needs to be confidential, the character string of the processing may be encrypted and transmitted.

The processing converted into the character string and the encrypted data is notified to the data detection unit 121 of the confidential processing unit 120 to first specify an encrypted data part (step S3300). The encrypted data is notified to the encryption processing unit 122 and decrypted (step S3400) to replace the data part yet to be decrypted in the information notified to the confidential processing unit 120 (step S3500). This is repeated while there is encrypted data. Then, processing is executed on the encrypted data originally expressed in a character string (step S3600). A result of the processing at the confidential processing unit 120 is encrypted for return of the result to the application 300 (step S3700) and then returned to the application 300 (step S3800).

This result is used to request the database to perform processing, similarly to the case in which no processing occurs on the encrypted data (step S3900). The application extension unit 200 can determine whether to provide processing on a parameter notified from the user system 100 at production of the parameter operation storage table 260. Thus, when an encryption scheme is configured by using the screen as illustrated in FIG. 10, the confidential processing unit 120 may be notified that encrypted data returns to the confidential processing unit 120 again. When the confidential processing unit 120 knows this information, dummy information may be notified at an application call in place of an encrypted parameter and replaced with plaintext data without performing the decryption processing at step S3400 illustrated in FIG. 11. The processing request (step S3900) from the encryption processing compatible application 300 to the database is notified to the application extension processing unit 200 in reality. The database processing extension unit 210 inside the application extension processing unit 200 refers to the encryption processing correspondence table 240 or the notified data and checks an encryption scheme used by the user system 100 as a requester (step S4100). This information is used to update the processing request to the database (step S4200). This change can be made by, for example, calling a script written in the encryption processing correspondence table 240, reading configuration information written in the encryption processing correspondence table 240 and performing processing in accordance with the configuration information, or replacing description of a corresponding computation part with a character string (for example, the name of an UDF function) written in the encryption processing correspondence table 240. This processing issues a request allowing the database to appropriately handle encrypted data. For example, when computation that cannot be processed by an encryption scheme used by the user system 100 is specified as processing on the database, the computation is stored and then an instruction to the database is replaced with a different instruction.

For example, at notification of an instruction to calculate a maximum value in a certain range to the database 400 when an encryption scheme in which a magnitude relation of data in an encrypted state cannot be determined is used, the conversion processing storage unit 250 stores that the original instruction is the instruction to calculate the maximum value, and then the instruction to calculate the maximum value is replaced with an instruction to acquire all in the specified range.

A specific content of this replacement processing is written to the encryption processing correspondence table 240 in a format such as a script. Processing to be executed when a result of the replacement is notified is registered to the conversion processing storage unit 250. This processing is processed by the database processing extension unit 210 inside the application extension unit 200. After the processing request to the database is changed appropriately, the database is actually requested to perform processing (step S4300).

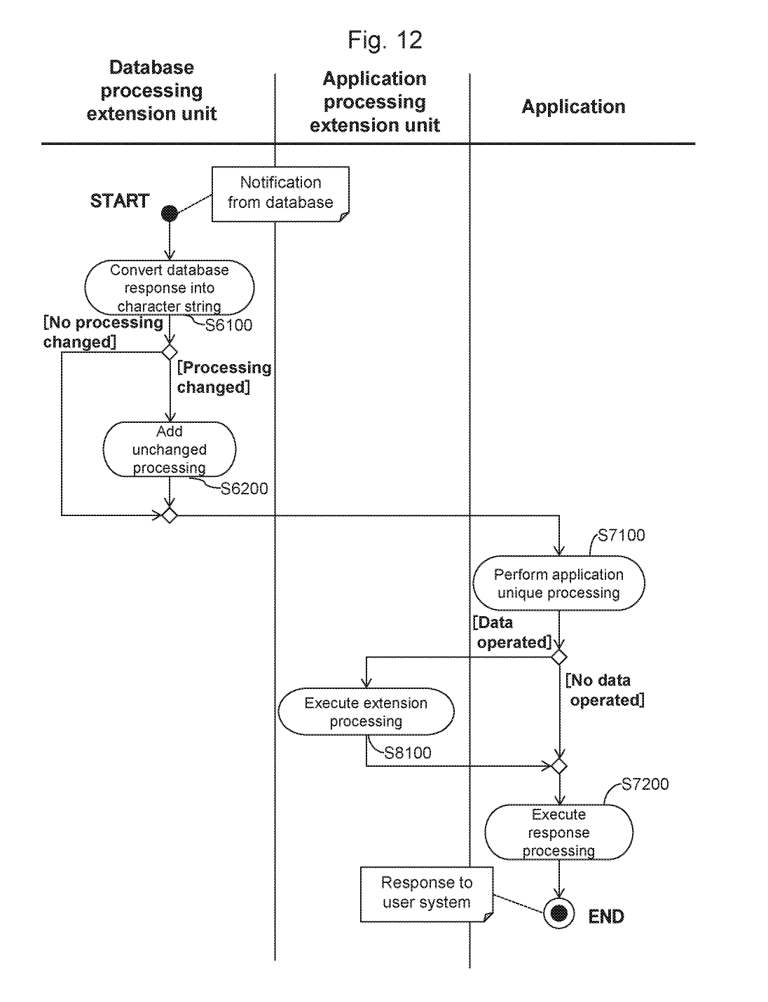

Having received the request, the database 400 instructs the encryption processing unit 410 to execute processing in accordance with a change instruction (step S5000). For example, the encryption processing unit 410 added as an UDF to the database 400 is called. The database 400 returns a result of the processing to the application extension unit 200. FIG. 12 illustrates a detailed flow through steps S6000, S7000, and S8000 at which the application extension unit 200 and the application 300 process the result of the processing by the database 400.

The result of the database processing is notified to the application extension unit 200. The database processing extension unit 210 inside the application extension unit 200 receives the notification and expresses each return value from the database, for example, as a character string (step S6100). When the original processing is changed by the database processing extension unit 210 at the processing request, processing that the entire character string expressing the return value from the database is provided with original computation stored in the conversion processing storage unit 250 is expressed and returned (step S6200). For example, processing for the above-described instruction to calculate the maximum value is changed to expression in a character string of “MAX({return value 1}, {return value 2}, . . . )”, and this character string is returned to the application as a result of the processing at the database 400.

A correspondence table of a character string expression and processing to be executed is prepared to allow the confidential processing unit 120 and the application extension unit 200 to share in advance a definition that processing of decrypting the character string stored in the parentheses and calculating a maximum value from a result thereof is to be executed when the character string of “MAX( )” is notified. In this example, the expression is made in a character string but may be in another format.

The encryption processing compatible application 300 directly uses received character string data as a result of the processing at the database. Thus, when no processing is performed on the data in particular, the application 300 uses the data as part of a response to be returned to the user system 100 (step S7200). When any computation or processing is provided on the received database processing result, this processing is not original processing at the application 300 but performed at the application processing extension unit 230 of the application extension unit 200. Specifically, processing same as that at step S3200 is executed. Through this processing, processing on encrypted data is expressed as, for example, a character string (step S8100). The application 300 returns, to the user system 100, a response that processing has been normally executed (step S7200). In this manner, the encrypted data and the processing on the encrypted data are converted into, for example, character strings and notified to the user system 100.

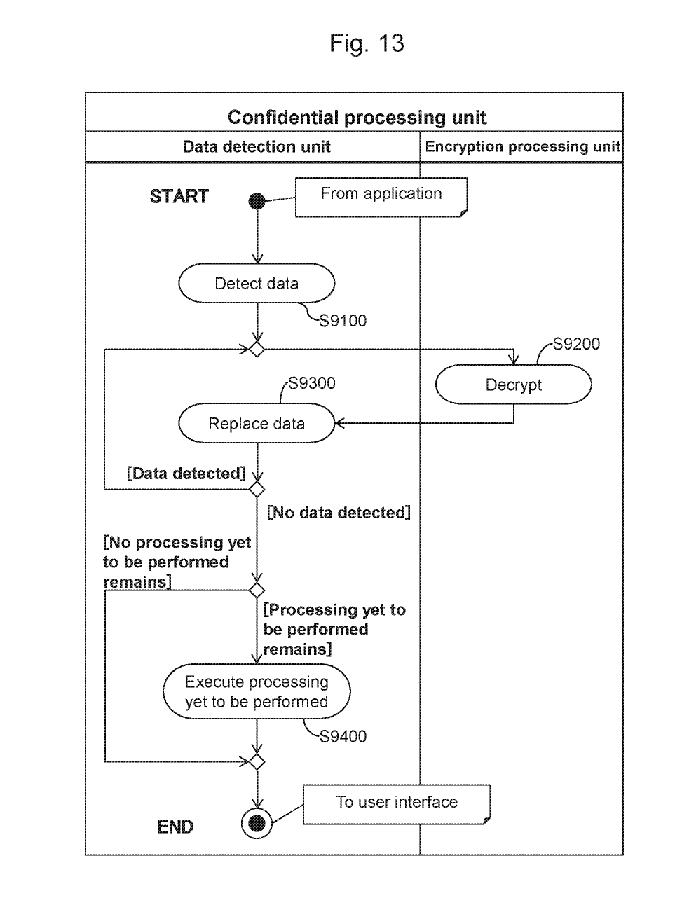

FIG. 13 illustrates a detailed flow of processing step S9000 at the confidential processing unit 120 having received a result of processing at the application 300 executed through the application processing extension unit 200.

First, a processing result returned from the encryption processing compatible application 300 is notified from the communication processing unit 130 to the data detection unit 121 inside the confidential processing unit 120. The data detection unit 121 detects encrypted data in the processing result notified from the application 300, (step S9100). When encrypted data is detected, the data is sent to the encryption processing unit 122 and decrypted (step S9200), original data in response data is rewritten to the decrypted data (step S9300). This is repeated while encrypted data exists.

Although FIG. 13 illustrates processing that decryption is performed at each detection of one piece of encrypted data, a request for collective decryption processing may be made after all pieces of encrypted data in the response data may be detected.

When the response data includes no processing on encrypted data that cannot be processed at the application 300 after all pieces of encrypted data are decrypted, the response data replaced with decrypted data is transmitted to the user interface 110, which ends processing. When processing on the encrypted data is replaced with different processing by the application processing extension unit 200, processing unperformed at the application is executed (step S9400). Then, similarly to a case in which there is no unperformed processing, a result of the processing is transmitted to the user interface 110, which ends processing at the confidential processing unit 120.

The application 300 in the external environment can process encrypted data through execution of the above-described processing steps without considering an encryption scheme used by the user system 100 at all.

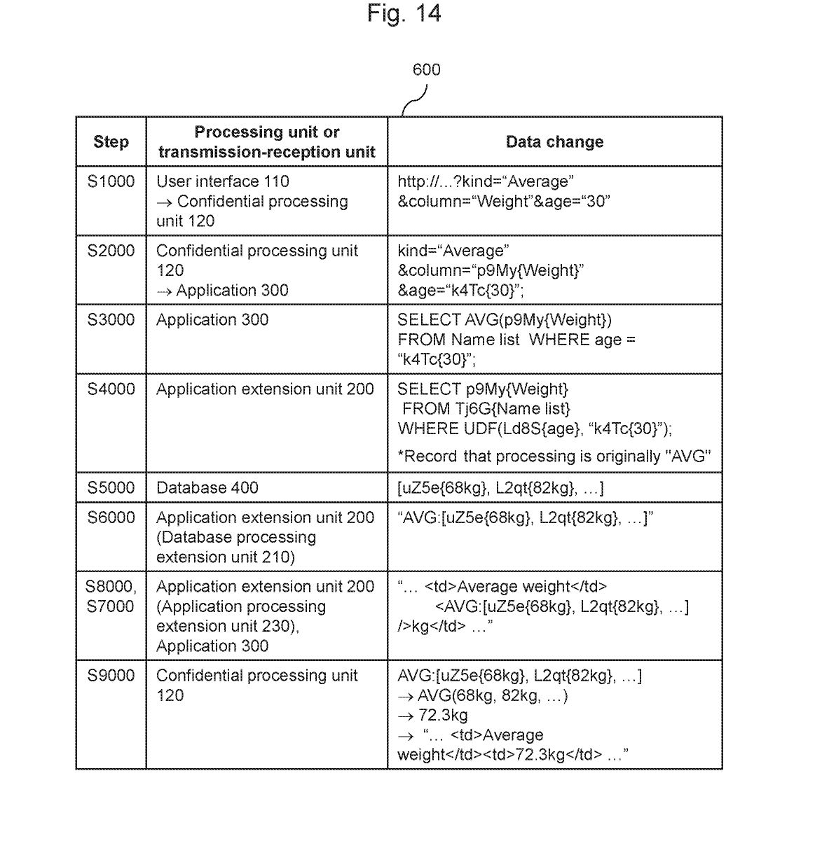

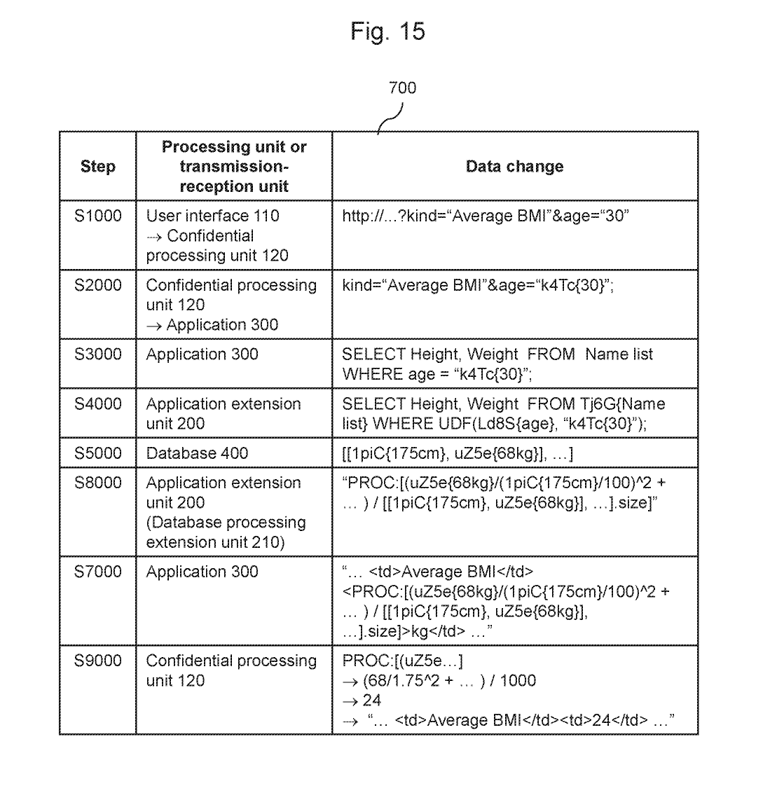

The following describes the above-described processing flow with reference to FIGS. 14 and 15 illustrating more specific processing examples in which data changes in “calculation of average weight at specified age” and “calculation of average BMI at specified age”. The application 300 illustrated in FIG. 1 is provided as a Web application that is a simple application configured to perform specified processing (sum, average, BMI average, maximum value, minimum value, . . . ) for an item (height, weight, age, . . . ) specified by a user.

It is assumed that data is encrypted by an encryption scheme that allows search in an encrypted state, and the database 400 stores, as personal information, information such as height, weight, age, and sex in an encrypted state. It is also assumed that access from the application 300 to the database 400 is performed in an SQL, and encryption processing (in this example, data match check processing) at the database 400 is achieved as a UDF. In FIGS. 14 and 15, plaintext data is enclosed in “{ }” to indicate that data is encrypted.

FIG. 14 illustrates processing of the “calculation of average weight at specified age”, and average processing is achieved by using an “AVG” function provided in the SQL. This example describes a processing method when a SQL function processing is needed on encrypted data.

First, the user operates the browser to instruct the application to “average the weights of thirty-year-old people” (step S1000). In the example illustrated in FIG. 8, data or the like is transmitted by the GET method of HTTP, but the transmission may be performed by POST in a format such as YAML or JSON. In this example, a processing type is set to “kind”, average target data is set to “column”, and age information for limiting processing target is set to “age”.

Having received the above information, the confidential processing unit 120 checks which parameter is to be encrypted by referring to the encryption data correspondence table 150, and encrypts the parameter (step S2000).

Having received the encrypted data, the application 300 generates an SQL for querying the database 400 by directly using the data (step S3000).

The encryption processing correspondence table 240 is referred to check whether there is an encryption compatible function for the SQL function “AVG” that calculates an average. If there is the compatible function, an “AVG” part is replaced with the encryption compatible function and an SQL sentence is notified to the database. If there is no compatible function, this means that the application has requested an SQL function that cannot be processed by this encryption scheme. In this case, a reason why the processing cannot be performed may be notified as an error by sending, from the application extension unit to the user system through the input-output unit 280, information indicating to which SQL function the processing that cannot be processed corresponds and an encryption type. The user refers to the reason through the user interface 110 of the user system and performs an appropriate measure. The following describes an exemplary method of performing existing processing extension without notifying an error when there is no encryption compatible function for “AVG”. The reference to the encryption processing correspondence table 240 indicates that no “AVG” is available, and thus the database processing extension unit 210 deletes “AVG” from the SQL sentence and changes the SQL sentence such that weight data of all entities is simply acquired from a target table. The conversion processing storage unit 250 stores “AVG”, which cannot be processed. The database processing extension unit 210 also acquires the name of a UDF to be called or the like by referring to the encryption processing table 240 (expressed in a character string of “UDF” in this example), and changes the SQL sentence such that the UDF is to be called. Encryption of the names of a column and a table or change of the names to different names are performed when needed. This SQL sentence change processing may be performed by calling processing listed in the encryption processing table 240 (step S4000). Having received the changed SQL, the database 400 returns a result of execution thereof (step S5000).

Having received the result, the database processing extension unit 210 checks the conversion processing storage unit 250 to determine that the SQL function “AVG” cannot be executed. This determination indicates that processing cannot be performed, and thus weight information received as a result is converted into a character string and provided with a mark indicating that the weight information is to be “averaged” (in this example, the characters “AVG” are provided at the start of the string) (step S6000).

The application 300 recognizes and processes a value returned from the database 400 as an already averaged weight value, but the value is returned as a character string in reality and thus cannot be directly processed. Thus, the application processing extension unit 230 calls changed processing. In this example, the value returned from the database 400, which is an average value, is a “numerical value”, but processing changed to handle this part as a “character string” is executed (step S8000). This ends processing at the application 300, and an HTML document to be displayed on the browser is returned as a result of the processing to the user system 100 (step S7000).

The “average processing” converted into a character string is included in the HTML document notified to the user system 100, and thus is detected by the data detection unit 121 of the confidential processing unit 120. Then, encrypted data is decrypted, and thereafter, the average processing that cannot be processed at the application 300 is executed to update the HTML document (step S9000).

In this manner, the encrypted data is converted into a plain text by the confidential processing unit 120, and the processing that cannot be processed at the application is executed, and notified to and displayed on the browser as the user interface 110 (step S10000).

FIG. 15 illustrates processing of the “calculation of average BMI at specified age”. The processing has a basic flow same as that of the “calculation of average weight at specified age”, but is different therefrom in that no SQL function is used and computation on encrypted data is performed in the application. This example describes a processing method when application internal processing needs to be changed for encrypted data.

First, the user notifies data and a processing method to the application 300 through a browser operation. The notified data is encrypted and transmitted to the application 300, and an SQL sentence corresponding to an encryption scheme is generated by the application processing extension unit and notified to the database 400 to obtain a result, which is processing completely same as that of the calculation of an average weight. In this example, however, no SQL function is used, and thus no change is made other than change of an SQL to call an UDF for processing encrypted data in the database, and the result of the processing at the database 400 is directly used (steps S1000 to S6000).

The application 300 performs computation to calculate a BMI by using a returned value. However, the returned value is encrypted and thus cannot be processed. To avoid this, the application processing extension unit 230 refers to the encryption processing correspondence table 240, and when there is, for example, an encryption compatible function that achieves computation on the encrypted data or a processing change script, the returned value is replaced with the function and processed before returned to the application. When there is no encryption compatible function, an error may be returned to notify the user similarly to the replacement of the SQL function. In this case, when information indicating to which SQL function processing that cannot be performed among pieces of processing requested by the user corresponds and an encryption type are sent to the user system through the input-output unit 280 and referred to by the user through the user interface 110, the user can perform an appropriate measure for the error.

The following describes a case in which an existing processing is extended similarly to the case with the SQL function. In this case, since there is no encryption compatible function, processing on encrypted data needs to be notified to the user system 100 and processed. For example, processing extended to convert computation on encrypted data into a character string is called. The processing converted into a character string is provided with a mark indicating processing at the confidential processing unit 120 (in this example, conversion is performed into a character string, and the characters “PROC” are provided at the start of the character string) (step S8000).

Similarly to the case for an average weight, the application 300 returns a result of executed processing to the user system 100 as a result of computation without problems (step S7000).

The following processing proceeds similarly to the case for an average weight, and the confidential processing unit 120 executes data decryption and BMI calculation processing converted into a character string, and returns a response to the user interface 110. Accordingly, when encrypted data is handled by the application internal processing, processing on the encrypted data can be achieved without considering the application.

In the two examples described above, data notified from the browser is directly used for the SQL, but in reality, the data is provided with some computation at the application, and a result thereof is used for an SQL sentence in some cases. Processing in this case is basically same as that at step S8000 and corresponds to processing at steps S3300 to S3800 illustrated in FIG. 11. Thus, in this case, too, encrypted data can be handled without problems.

In the examples described above, processing on encrypted data at the application 300 is converted into a character string and performed at the confidential processing unit 120, but in another exemplary achieving method, processing returned to the user system 100 may be converted into JavaScript (registered trademark) instead of a character string and returned to the user system 100. In this case, the encrypted data may be decrypted in the confidential processing unit 120, and processing on the encrypted data converted into JavaScript may be executed at the browser used as the user interface 110. In the embodiment described above, it is assumed that the source code of an application is rewritten, but a binary image such as Java or C language may be used.

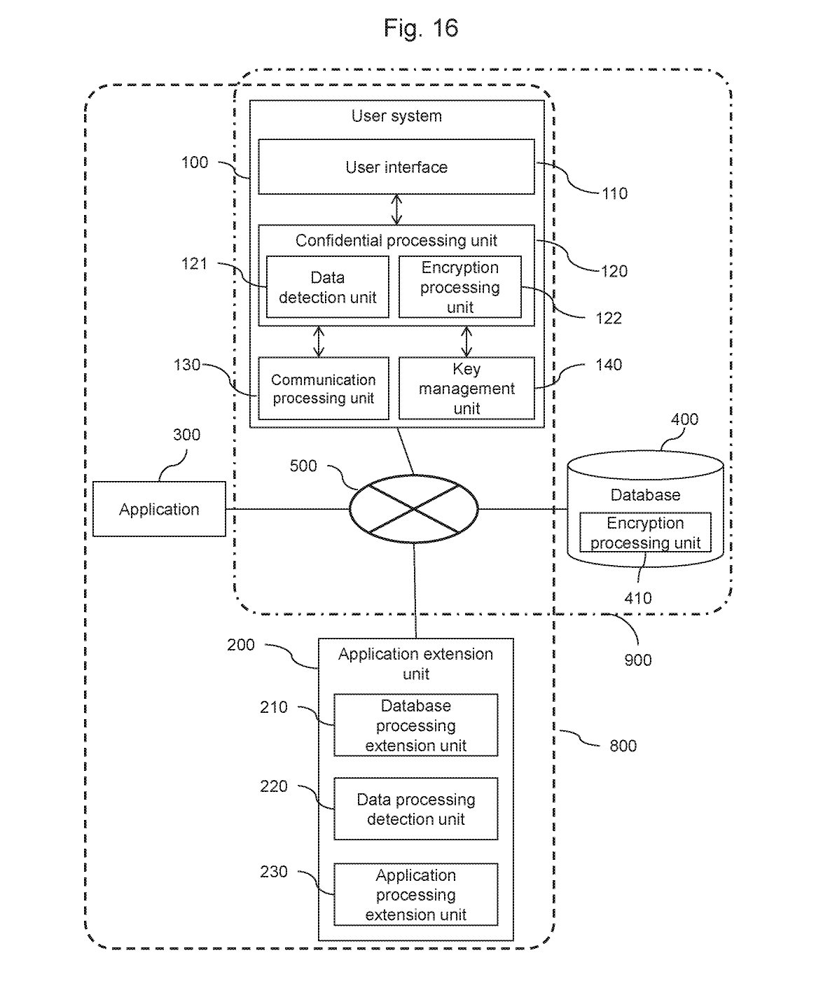

The above describes an exemplary environment in which the user system 100, the application extension unit 200, the application 300, and the database 400 are operated in separate environments. In another embodiment, the application extension unit 200 and the application 300 are provided in the user system 100 whereas only the database 400 is provided externally, or the database 400 is provided in the user system whereas the application extension unit 200 and the application 300 are provided out of the user system 100. FIG. 16 illustrates these configurations. The configuration in which the database 100 is externally provided is referred to as a configuration 800, and the configuration in which the application is externally provided is referred to as a configuration 900. In this manner, optional configurations can be selected, and thus any configuration in accordance with a data confidential degree and a system configuration is applicable.

In the configuration 800, the application 300 operates in the user system 100 in which raw data can be handled, and thus there is no need to convert internal processing at the application 300. However, processing at the database needs to be changed. The data detection unit 121 and the encryption data correspondence table 150 are not used for communication between the user interface 110 and the application 300, but used for communication between the confidential processing unit 120 and the database 400. Thus, in the encryption data correspondence table 150, a database to be used, the names of a table and a column, and an encryption scheme are associated with each other.

When an application that operates in an environment separated from the outside, such as the inside of the user system is developed, a developer of the application needs to be a user or one asked by the user to maintain a separated environment. When encryption is used, the developer needs to achieve implementation that takes into account computation compatible with an encryption scheme, which degrades the portability of the application. However, when the application extension unit 200 according to the present invention is introduced, the application developer can perform development without considering the encryption scheme. A processing flow in this case is a procedure substantially same as that in a first embodiment except for change of a processing order, and the processing is performed through the user interface 110, the application 300, the application extension unit 200, the confidential processing unit 120, and the database 400 in this order.

The configuration 900 can be achieved when processing executed on encrypted data at the application 300 is converted into, for example, a character string or JavaScript and executed at the user system 100. Since the database 400 is provided in the user system 100, processing at the database can be used in the user system without encryption taken into consideration. Thus, the database processing extension unit 210, the conversion processing storage unit 250, and the database encryption processing management table 270 inside the application extension unit 200, and the encryption processing unit 410 inside the database 400 are unnecessary unlike in the first embodiment. Processing flows through the user interface 110, the confidential processing unit 120, the application 300, the application extension unit 200, the application 300, and the database 400 in this order, and in this manner, the processing is performed through the application extension unit 200 several times since the application 300 is provided out of the user system 100 whereas the database 400 is provided in the user system 100. Processing at each processing unit is basically same as that in another configuration.

In the above-described embodiments, characteristics of the present invention are achieved by using the application extension unit 200 as a frame work. In this manner, instead of changing the content of processing at the application 300 through the application extension unit 200 dynamically or at deployment of the application 300, an application provided with processing performed by the application extension unit 200 may be prepared by the application developer in advance and used to achieve the present scheme. This method is roughly same as a method of producing an executable file in accordance with a correspondence environment by compiling a source code.

In all above-described embodiments, a third party provides, as a service, a system outside of the user system 100 in some cases. In such a case, it is probable that only an encryption scheme provided by the service provider is available. Thus, when an encryption scheme that is used by the user or that the user desires to use is different from an encryption scheme provided by a service, such a configuration may be provided that the user is notified at an appropriate timing such as a timing at which the application 300 is first accessed or a timing at which the application 300 is deployed.

### REFERENCE SIGNS LIST

100 user system, 110 user interface, 120 confidential processing unit, 121 data detection unit, 122 encryption processing unit, 130 communication processing unit, 140 key management unit, 150 encryption data correspondence table, 200 application extension unit, 210 database processing extension unit, 220 data processing detection unit, 230 application processing extension unit, 240 encryption processing correspondence table, 250 conversion processing storage unit, 260 parameter operation storage table, 270 database encryption processing management table, 300 application, 400 database, 410 encryption processing unit

1. An encryption processing system comprising an application extension unit coupled with a database through a network, wherein
the database stores encryption data obtained by encrypting plaintext data,
the application extension unit includes:
a processing request reception unit configured to receive a request from an application to the database to process the data;
a database processing extension unit configured to refer to an encryption processing correspondence table,
change, when the encryption processing correspondence table stores an encryption data processing function corresponding to a plaintext data processing function included in the processing request, the plaintext data processing function of the processing request to the encryption data processing function, or
change, when the encryption processing correspondence table stores no encryption data processing function corresponding to the plaintext data processing function included in the processing request, the processing request to processing of requesting encryption data necessary for the plaintext data processing function to execute processing, and
send the changed processing request to the database; and
an execution result reply unit configured to return, to a user system, a result of processing of the encryption data processing function received from the database and a processing request execution result including the encryption data necessary for the plaintext data processing function to execute processing.

2. The encryption processing system according to claim 1, wherein the user system includes an encryption processing unit configured to decrypt, when having received the processing request execution result including the encryption data necessary for the plaintext data processing function to execute processing, the received encryption data and execute processing of a plaintext data processing function having no encryption data processing function by using the decrypted encryption data.

3. The encryption processing system according to claim 2, wherein
the user system includes an encryption data correspondence table storing data and an encryption scheme for the data in association with each other, and
the user system refers to the encryption data correspondence table and decrypts the received encryption data in accordance with an encryption scheme corresponding to the encryption data.

4. The encryption processing system according to claim 1, further comprising a conversion processing storage unit storing a computation processing content necessary for execution of a plaintext data processing function, wherein, when the encryption processing correspondence table stores no encryption data processing function corresponding to a plaintext data processing function, the execution result reply unit refers to the conversion processing storage unit and notifies computation processing necessary for processing of the plaintext data processing function to the user system.

5. The encryption processing system according to claim 3, wherein the user system associates an application with data processed by the application and requests the application extension unit to execute the application.

6. The encryption processing system according to claim 4, wherein the execution result reply unit returns information indicating that the request cannot be processed to the user system, when the encryption processing correspondence table stores no encryption data processing function corresponding to a plaintext data processing function and the conversion processing storage unit stores no calculation processing necessary for processing of the plaintext data processing function.

7. An encryption processing method for an encryption processing system comprising an application extension unit coupled with a database through a network, wherein
the database stores encryption data obtained by encrypting plaintext data,
the application extension unit includes a processing request reception unit, an application processing extension unit, and an execution result reply unit,
the processing request reception unit receives a request from an application to the database to process the data,
the application processing extension unit
refers to an encryption processing correspondence table,
changes, when the encryption processing correspondence table stores an encryption data processing function corresponding to a plaintext data processing function included in the processing request, the plaintext data processing function of the processing request to the encryption data processing function, or
changes, when the encryption processing correspondence table stores no encryption data processing function corresponding to the plaintext data processing function included in the processing request, the processing request to processing of requesting encryption data necessary for the plaintext data processing function to execute processing, and
a database processing extension unit in which the execution result reply unit sends the changed processing request to the database, and
returns, to a user system, a result of processing of the encryption data processing function received from the database, and a processing request execution result including the encryption data necessary for the plaintext data processing function to execute processing.

8. The encryption processing method according to claim 7, wherein the user system includes an encryption processing unit configured to decrypt, when having received the processing request execution result including the encryption data necessary for the plaintext data processing function to execute processing, the received encryption data and execute processing of a plaintext data processing function having no encryption data processing function by using the decrypted encryption data.

9. The encryption processing method according to claim 8, wherein
the user system includes an encryption data correspondence table storing data and an encryption scheme for the data in association with each other, and
the user system refers to the encryption data correspondence table and decrypts the received encryption data in accordance with an encryption scheme corresponding to the encryption data.

10. The encryption processing method according to claim 7, further comprising a conversion processing storage unit storing a computation processing content necessary for execution of a plaintext data processing function, wherein, when the encryption processing correspondence table stores no encryption data processing function corresponding to a plaintext data processing function, the execution result reply unit refers to the conversion processing storage unit and notifies computation processing necessary for processing of the plaintext data processing function to the user system.

11. The encryption processing method according to claim 9, wherein the user system associates an application with data processed by the application and requests the application extension unit to execute the application.

12. The encryption processing method according to claim 10, wherein the execution result reply unit sends information indicating that the request cannot be processed to the user system, when the encryption processing correspondence table stores no encryption data processing function corresponding to a plaintext data processing function and the conversion processing storage unit stores no computation processing necessary for processing of the plaintext data processing function.
